(19) United States
(12) Patent Application Publication
(10) Pub. No.: US 2024/0353019 A1
(43) Pub. Date: Oct. 24, 2024

(54) SERVO VALVE

(71) Applicant: A.U.K. MÜLLER GMBH & CO. KG, Düsseldorf (DE)

(72) Inventors: Wolfgang ARNDT, Düsseldorf (DE); Gerd BERGER, Düsseldorf (DE); Markus MÜNSTERMANN, Düsseldorf (DE); Dennis RECHENBACH, Düsseldorf (DE)

(21) Appl. No.: 18/686,590

(22) PCT Filed: Sep. 1, 2022
(86) PCT No.: PCT/DE2022/100650

§ 371 Date: Feb. 26, 2024

(30) Foreign Application Priority Data
Sep. 2, 2021 (DE) 10 2021 122 779.8

(51) Int. Cl. F16K 31/00; F16K 31/365

(52) U.S. Cl. CPC F16K 31/003; F16K 31/365

(57) ABSTRACT

A servo valve, with a valve housing, a main valve and a pilot valve which can be actuated via a push-push mechanism for adjusting the main valve between an open position and a closed position. Two setting discs are provided which are arranged to rotate relative to each other for setting the open position.

### CROSS-REFERENCE TO RELATED APPLICATIONS

This application is a national stage filing of PCT International Application No. PCT/DE2022/100650 (corresponding to International Publication No. WO 2023/030582) filed on Sep. 1, 2022, which in turn claims priority to German Application No. 10 2021 122 779.8 filed on Sep. 2, 2021. The entire contents of both of those applications are incorporated by reference herein.

The present disclosure relates to a valve, in particular a servo valve, with a valve housing, a main valve and a pilot valve which can be actuated via a push-push mechanism for adjusting the main valve between an open and a closed position.

### BACKGROUND

Valves of this type are used in various areas of technology to control especially fluid flows, for example in sanitary fittings or other applications.

A main valve is arranged within the valve housing of the valve, which can be adjusted between an open and a closed position to control the fluid flow. In contrast to direct-switching valves, which often require a comparatively large amount of energy to actuate the main valve, a smaller pilot valve is used to adjust the main valve, which, supported by the operating pressure of the fluid flow to be switched, allows the main valve to be switched with a lower energy requirement.

In some valves of this type, the pilot valve is actuated by manually operating a push-push mechanism, which can be used to adjust the pilot valve between two switching positions, which also allows the main valve to be adjusted between its closed and open positions.

However, there are also applications where flow rate regulation is required, i.e. the fluid flow should not only be switched between the closed and fully open position, for example in the case of a sanitary fitting or similar applications.

In this context, it is known from EP 3 593 022 A1 to provide a push-push mechanism with three switching stages for actuating a pilot valve, in which a first switching stage corresponds to the fully closed position, a second switching stage corresponds to the fully open position and a third switching stage corresponds to an intermediate position. By repeatedly actuating the push-push mechanism, the three switching stages can be switched through one after the other and an intermediate position of the fluid flow can also be set in this way. Although this type of valve allows for graduated flow regulation, the handling has proven to be disadvantageous due to the need for multiple actuation of the push-push mechanism and is often perceived as cumbersome by users of conventional sanitary fittings, for example.

Another valve with a flow rate regulator is known from EP 3 740 708 A1, in which a sleeve-shaped setting element surrounding the manual control element of the push-push mechanism is provided, by means of which a pressure element of the push-push mechanism can be adjusted via a detented stop line. With this valve, the push-push mechanism can be used to switch back and forth between the closed position and the open position. The flow rate in the open position can be adjusted by turning the sleeve surrounding the push-push mechanism. This is achieved via two stop points formed on the sleeve, which interact with two stop lines provided on the manual control element with a filigree latching mechanism and limit the axial movement of the manual control element at certain points.

This type of valve actuation has also proven to be disadvantageous in practice, as a first manual control element is required to actuate the push-push mechanism and a second, sleeve-shaped manual control element is required to set the flow rate. A further disadvantage of this valve is that there is a risk of increased wear due to the fact that the stop points are only positioned at certain points on the associated stop lines, which can prove to be disadvantageous, particularly in the case of valves that are sometimes adjusted daily over very long periods of time, for example in a sanitary fitting.

### SUMMARY

On this background the present disclosure provides a valve in which flow rate regulation is possible in a user-friendly manner that is less susceptible to wear.

This advantage is solved in a valve of the type mentioned at the beginning by providing two setting discs arranged to be rotatable relative to each other for setting the open position.

The setting discs can be used to set the open position and thus regulate the flow rate in a user-friendly manner. The setting discs can lie flat against one another over large parts of their setting range and transmit the required setting forces. Point contact of the components loaded by the actuating forces or the spring force of the push-push mechanism is avoided, resulting in a favorable design that is less susceptible to wear.

In another particularly advantageous design the setting discs form a pair of lifting discs. The pair of lifting discs can be operatively connected to the push-push mechanism. The advantage of a pair of lifting discs is that the corresponding rotary movement can be easily converted into an axial movement which can be used to actuate the push-push mechanism by turning the setting discs towards each other.

In this context, it is also proposed that the setting discs have inclined setting surfaces. A rotary movement can be converted into an axial movement via the inclined positioning surfaces. The transmission ratio between the rotary and axial movement can be adjusted via the angle of the inclined setting surfaces. Furthermore, the angle can be used to achieve self-locking, so that the setting discs always retain their rotary position and unintentional backward rotation is prevented.

One advantageous design feature is that the setting discs each have two setting surfaces. This allows the actuating forces to be transmitted evenly. The required actuating forces are also distributed over two setting surfaces. This results in low wear.

Advantageously, stops for limiting the rotary movement are arranged between the two respective setting surfaces. The stops prevent over-rotation. The angle of rotation is limited to an angle of less than 180°. Advantageously, the stops define the maximum flow rate and the minimum flow rate in the open position of the main valve.

A particularly advantageous embodiment provides for the setting discs to be arranged on a setting attachment that is detachably mounted on the valve housing and/or the push-push mechanism, via which the open position can be set to regulate the flow rate. The flow rate of the valve can be set in a simple and user-friendly manner using the setting attachment. Thanks to the detachable arrangement on the valve housing and/or the push-push mechanism, the setting attachment can also be easily retrofitted to valves without flow rate regulation. In particular, it is not necessary to dismantle an existing valve in order to retrofit it with a flow rate control. The actuator can be retrofitted to an existing valve in just a few simple steps.

In another advantageous design, the push-push mechanism can be operated via the setting attachment. In this way, the setting attachment has a dual function. On the one hand, the setting attachment can be used to set the open position of the main valve for flow rate regulation. In addition, the setting attachment can also be used to switch the pilot valve and the main valve between its open and closed position. In this context, it is advantageous if the setting attachment is designed in such a way that it can be operated with one hand, both to actuate the push-push mechanism and to regulate the flow rate.

A further advantageous embodiment is that a manual control element is provided, wherein the push-push mechanism can be operated by pressing the manual control element and the open position can be set by rotating the manual control element. The manual control element can be a hand-operated element that can be touched directly by the operator's hand. Alternatively, it can also be such an element onto which, for example, a chrome-plated operating knob of a sanitary fitting is attached. The manual control element can be part of the setting attachment. The push actuation of the manual control element can take place in the pilot control direction of the pilot valve and/or along the main valve axis of the valve. A return spring can be used to reset the valve. The open position of the main valve can be adjusted by a rotary actuation of the manual control element. The rotary actuation can be designed in such a way that the flow rate is reduced by turning in one direction and the flow rate is increased by turning in the opposite direction. In particular, it can be provided that the flow rate is increased by turning anti-clockwise and reduced by turning clockwise, which is familiar to the user from other applications and therefore allows intuitive flow rate regulation.

A structurally advantageous further development also provides for a setting disc to be detachably connected to the push-push mechanism. For example, the setting disc can be fitted onto a pressure element of the push-push mechanism coming from the axial direction. The connection between the setting disc and the push-push mechanism can be made by clamping, latching and/or positive locking. For example, the setting disc can have a recess corresponding to the outer contour of the pressure element of the push-push mechanism. It can be useful if the setting disc is connected to the push-push mechanism so that it cannot rotate.

An advantageous design in terms of installation is that a setting disc is arranged at the manual control element. This is because in this way, the setting disc can be arranged on the valve together with the manual control element in a single assembly step.

An advantageous design in terms of manufacturing technology is that the setting disc is connected to the manual control element in one piece. For example, the setting disc can be molded in one piece onto the manual control element using an injection molding process. This reduces the number of parts and also the assembly effort.

A further advantageous embodiment is that the manual control element is connected, in particular latched, to the valve housing. The manual control element is supported against the valve housing via the connection to the valve housing. An advantageous embodiment is that the connection is a latching connection. The manual control element can be connected to the valve housing without tools thanks to the latching connection of the manual control element to the valve housing.

A further advantageous embodiment provides for the manual control element to be connected to the valve housing in such a way that it can be moved axially in the direction of the push-push mechanism against the force of a tensioning spring and can rotate relative to the valve housing. By applying a pressure force onto the manual control element, it can be moved axially against the force of the tensioning spring. This axial movement can be used to actuate the push-push mechanism. Due to the rotatable arrangement of the manual control element in relation to the valve housing, the open position of the main valve for flow rate regulation can be adjusted by turning the manual control element.

A further advantageous embodiment provides for the manual control element to have latching elements that are latched to a latching structure arranged on the valve housing. The latching elements can be molded in one piece on the manual control element.

In this context, it has proven to be advantageous if the latching elements are formed on resilient tongues. The tongues equipped with the latching elements form latching tongues. In addition to the latching tongues, peripheral areas of the manual control element may also not contribute to latching. For example, it may be provided that the cylindrical hand control element is divided into evenly spaced tongues in an end region, with approximately every second, third or fourth tongue being formed as a latching tongue.

With regard to the latching structure arranged on the valve housing, it has proven to be advantageous if it is designed in the form of a circumferential latching collar. In particular, the latching collar can be arranged over an angular range of 360° around the entire circumference of the valve housing. The latching collar can be an annular projection. Stabilizing elements extending in the axial direction can be arranged above the latching collar, which rest against the inside of the manual control element and guide its axial and rotational movements. The tensioning spring reliably returns the manual control element to its initial axial position. For the operator, the manual control element is always in the same axial position after operation. This is also conducive to ease of use.

### BRIEF DESCRIPTION OF DRAWINGS

Further details and advantages of a valve are explained below referring to the attached drawings of an example embodiment. The drawings depict the following:

FIG. 1 is a perspective view of a valve,

FIG. 2 is a partially sectioned view of the valve as shown in FIG. 1,

FIG. 3a) is a partially exploded view of the valve according to FIG. 1,

FIG. 3b) is a partially exploded view of the valve according to FIG. 1,

FIG. 4 is another exploded view of components of the valve according to FIG. 1,

FIG. 5a) is a detailed view of a manual control element with a setting disc arranged on it,

FIG. 5b) is a detailed view of a manual control element with a setting disc arranged on it,

FIG. 6a) is a detailed view of a setting disc,

FIG. 6b) is a detailed view of a setting disc,

FIG. 6c) is a detailed view of a setting disc,

FIG. 7a) is a partially sectioned view of the valve as shown in FIG. 1 in its open position, indicating the maximum open position,

FIG. 7b) is a partially sectioned view of the valve as shown in FIG. 1 in its open position, indicating an intermediate position,

FIG. 7c) is a partially sectioned view of the valve as shown in FIG. 1 in its open position, indicating the minimum open position,

FIG. 8a) shows the valve as shown in FIG. 1 in a sectioned view in its open position, indicating the maximum open position,

FIG. 8b) shows the valve as shown in FIG. 1 in a sectioned view in its open position, indicating an intermediate position,

FIG. 8c) shows the valve as shown in FIG. 1 in a sectioned view in its open position, indicating the minimum open position,

FIG. 9a) shows a partially sectioned view of the valve as shown in FIG. 1 in its open position, indicating the maximum open position,

FIG. 9b) shows a partially sectioned view of the valve as shown in FIG. 1 in its open position, indicating an intermediate position, and

FIG. 9c) shows a partially sectioned view of the valve as shown in FIG. 1 in its open position, indicating the minimum open position.

### DETAILED DESCRIPTION

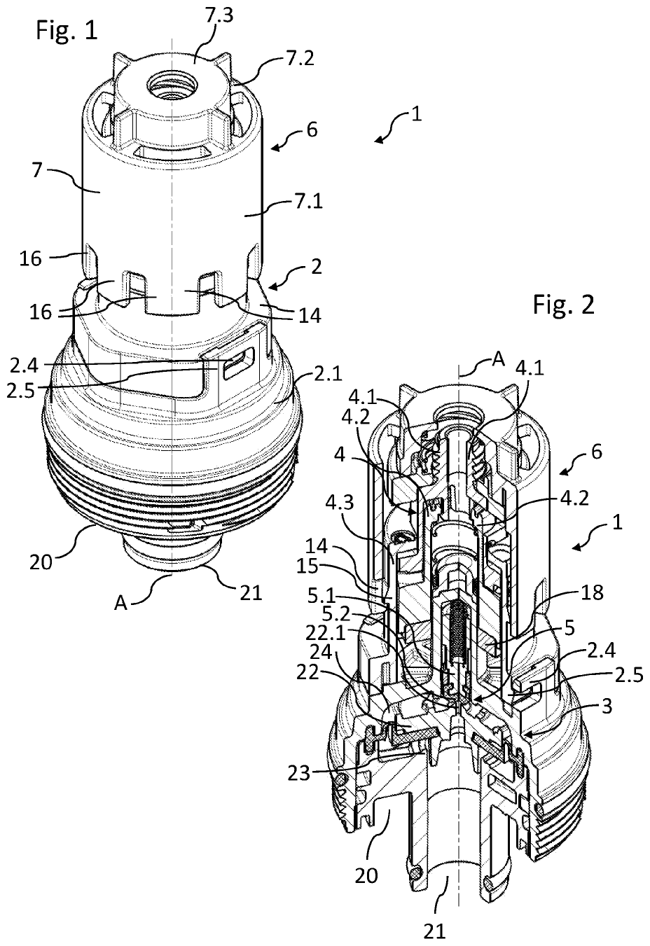

The illustrations in FIGS. 1 and 2 show a perspective and partially sectioned view of a valve 1 designed as a cartridge valve. It is a servo valve of the type used in the sanitary sector, for example in shower fittings.

The valve 1 has a valve inlet 20 and a valve outlet 21 arranged coaxially to it. In this respect, it is a coaxial valve. A main valve 3 is arranged in the flow path between the valve inlet 20 and the valve outlet 21, which is shown in its open position in FIGS. 1 and 2. In this position, an annular gap arranged between the closing element 22 of the main valve 3 and the valve seat 23 of the main valve 3 opens the flow path between the valve inlet 20 and the valve outlet 21. The closing element 22 is a closing diaphragm, the position of which can be controlled via a pilot valve 5 of smaller diameter.

The pilot valve 5 has a movably arranged pilot control element 5.1, which interacts with a control opening 22.1 of the closing element 22. The pilot control element 5.1 is designed in the manner of a magnetic plunger and interacts with a magnet 18 formed as a permanent magnet. The pilot control element 5.1 is magnetically coupled to the magnet 18. The magnet 18 is operatively connected to the push-push mechanism 4. When the push-push mechanism 4 is actuated, the magnet 18 is moved along the valve axis A of the valve 1. Due to the magnetic coupling, the pilot control element 5.1 follows this movement and can thus be switched back and forth in a bistable manner between two end positions by actuating the push-push mechanism 4.

In the closed position of the main valve 5, the pilot control element 5.1 closes the control opening 22.1 of the closing element 22 with a sealing surface 5.2. In this position, the closing element 22 is pressed onto the valve seat 23 by the pressure of the applied fluid and seals it fluid-tight. By actuating the push-push mechanism 4, the magnet 18 is moved to its other stable end position. The pilot control element 5.1, which is magnetically coupled to the magnet, is moved along with it and releases the control opening 22.1. The fluid can now flow from a pressure chamber 24 arranged above the closing element 22 via the control opening 22.1 into the valve outlet 21, whereby the pressure conditions inside the valve 1 change so that the closing element 22 is lifted above the pressure of the fluid present.

When the closing element 22 is lifted, the pilot control element 5.1 forms a hydraulic stop that limits its stroke. The closing element 22 is initially raised by the pressure of the fluid at the valve inlet 20 until it comes into contact with the sealing surface 5.2 of the pilot control element 5.1 positioned above it. The control opening 22.1 is thereby briefly closed and the closing element 22 is moved in the opposite direction by the pressure building up above the closing element 22 until the control opening 22 is opened again. This results in a kind of oscillating movement of the closing element 22, whereby after a few oscillations a floating state of the closing element 22 is achieved just below the pilot control element 5.1. The resulting position of the closing element 22 depends on the axial position of the pilot control element 5.1 and has a direct influence on the flow rate of the valve 1. The axial position of the pilot control element 5.1 of the pilot valve 5, which acts as a hydraulic stop, can therefore be used to regulate the flow rate flowing through the valve 1.

The valve 1 has a valve housing 2 in which the components of the valve 1 are accommodated. The valve housing 2 has two housing parts 2.1, 2.2. The two housing parts 2.1, 2.2 are connected to each other via a connection point 2.3. In the example embodiment, the connection point 2.3 is designed as a latching connection with latching elements 2.4, 2.5 arranged on opposite sides of the valve housing 2 and each forming a latching connection. The housing part 2.1 houses hydraulic components of the valve 1, such as the main valve 3, the pilot valve 5 as well as the valve inlet 20 and the valve outlet 21. In this respect, the housing part 2.1 is a hydraulic housing. The components for switching the main valve 2, such as the push-push mechanism 4 and the magnet 18, are housed in the other housing part 2.2. In this respect, housing part 2.2 is a switch housing.

As will be explained in more detail below, valve 1 can not only be switched between its closed position and the fully open position shown in FIG. 2, but can also be steplessly set for the purpose of regulating the flow rate.

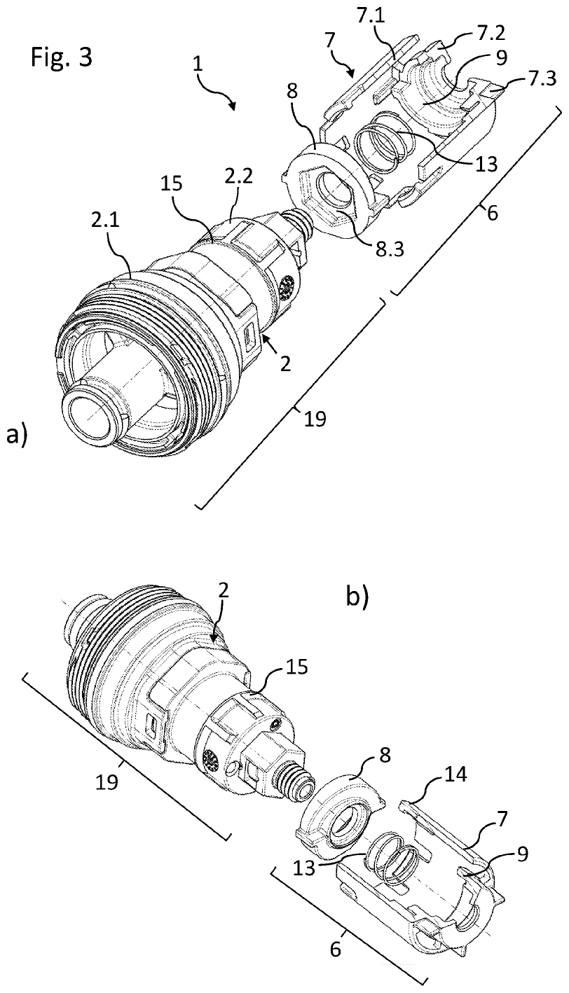

To regulate the flow rate, the valve 1 has a setting attachment 6 that can be mounted on a base valve unit 19 of the valve 1 in the axial direction, see FIGS. 3a) and 3b). Even without the setting attachment 6, the base valve unit 19 forms a functional servo valve, i.e. a fluid flow could be switched between the closed and a fully open position of the main valve 3 via the push-push mechanism 4. The function of the basic valve unit 19 is easily supplemented by flow rate regulation via the setting attachment 6. For this purpose, the setting attachment 6 can also be detachably connected to the valve housing 2 and the push-push mechanism 4, which are parts of the basic valve unit 19, as a retrofit solution in just a few simple steps.

To regulate the flow rate, the valve 1 has a manual control element 7, two interacting setting discs 8, 9 and a spring 13 serving as a reset element. In the embodiment example, the manual control element 7, which is designed in the form of a push button, the setting discs 8, 9 and also the spring 13 are part of the setting attachment 6, which is detachably connected to the valve housing 2 or the push-push mechanism 4. Alternatively, however, the corresponding parts could also not be part of a setting attachment 6, but instead be non-detachably connected to the valve housing 2 or the push-push mechanism 4.

As the illustration in FIG. 1 shows, the manual control element 7 has an overall pot-shaped geometry. The manual control element 7 has an essentially cylindrical casing 7.1 and a base 7.2. A connecting means 7.3 is provided on the base 7.2, to which the manual control element 7 can be connected with a cap. For example, a chrome-plated cover cap of a sanitary fitting can be arranged on the connecting means 7.3, which is adapted to the design of the respective fitting and has labelling for operating the fitting.

The manual control element 7 extends axially along the valve axis A and is connected to the housing part 2.2 of the valve housing 2 at the end opposite its operating side. For connection to the valve housing 2, the manual control element 7 has several tongues 16 at its open end, which are distributed around the circumference of the manual control element 7 and extend coaxially to the valve axis A. Some of the tongues 16 are provided with latching elements 14. In the embodiment example, every second tongue 16 is provided with a latching element 14. The remaining tongues 16 are used to guide the movements of the manual control element 7. However, fewer or more tongues 16 can also be provided with latching elements 14.

The latching elements 14 interact with a latching structure 15 provided on the valve housing 2. The latching structure 15 is designed in the form of a radial projection that surrounds the valve housing 2 in an annular shape, see FIGS. 3a) and 3b). The latching structure 15 is arranged on the housing part 2.2 and is connected to it in one piece. The manual control element 7 can be latched to the latching structure 15 of the valve housing 2 from an axial direction along the valve axis A via the latching elements 14, see also FIG. 2. The cap-shaped control element 7 is latched to the housing 2 in such a way that the manual control element 7 can be moved in an axial direction towards the base valve unit 19 against the force of the tensioning spring 13. The manual control element 7 is reset via the spring 13 so that the latching elements 14 always endeavor to come into contact behind the latching structure 15. The latching connection of the manual control element 7 to the valve housing 2 is also such that the manual control element 7 is freely rotatable relative to the housing 2.

By applying pressure, the manual control element 7 can be moved axially against the force of the tensioning spring 13. This axial movement is used to actuate the push-push mechanism 4. The rotary movement of the manual control element 7 can be used to regulate the flow rate of the valve 1 in its open position.

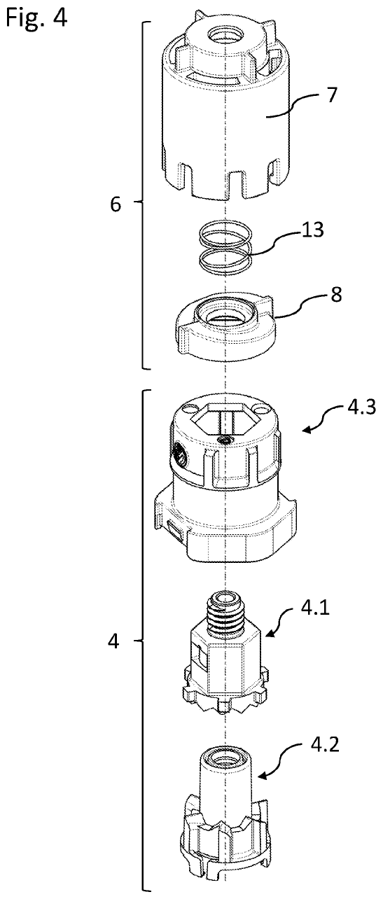

FIG. 4 shows the setting attachment 6 and parts of the push-push mechanism 4 of the basic valve unit 19. As can be seen, the push-push mechanism 4 is designed in the manner of a conventional ballpoint pen mechanism. By applying pressure to the pressure element 4.1, an axial and rotational adjustment of a feed element 4.2 takes place within a sleeve 4.3 of the housing part 2.2, as known from ballpoint pens. By actuating the pressure element 4.1 of the push-push mechanism 4, which is coupled to the pilot control element 5.1 of the pilot valve 5, the pilot control element 5.1 can be bistably switched back and forth between two end positions.

As the illustrations in FIGS. 3a) and 3b) show, the valve 1 has two correspondingly designed setting discs 8, 9.

The setting disc 8 is formed by a separate component. The setting disc 8 is non-rotatably connected to a pressure element 4.1 of the push-push mechanism 4, in the example embodiment via a plug-in connection. The other setting disc 9 is arranged on the inside of the manual control element 7. In the embodiment example, the setting disc 9 is integrally connected to the manual control element. The setting disc 9 is arranged on the base 7.2 of the manual control element 7. The setting disc 9 is arranged on the side opposite the connecting means 7.3.

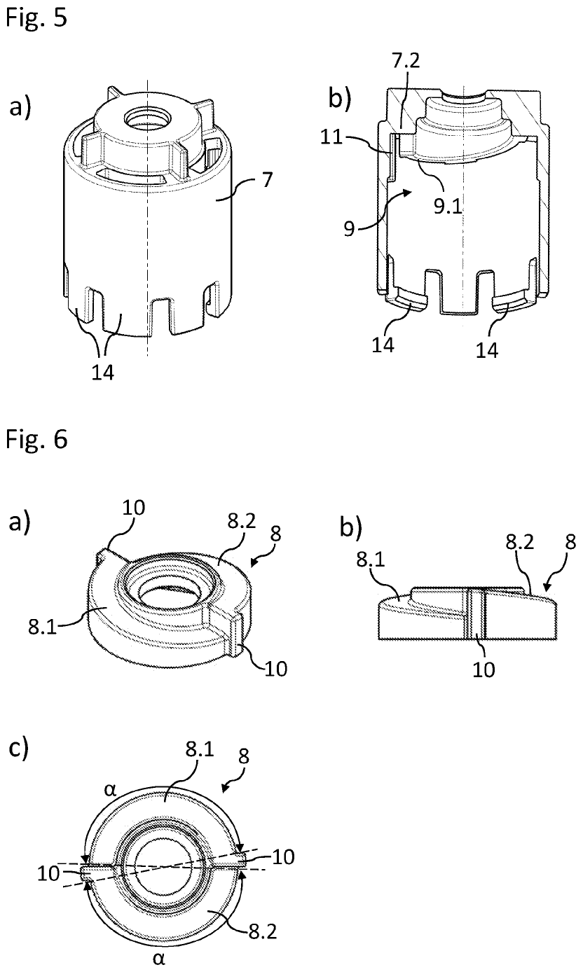

Both the setting disc 8 and the setting disc 9 each have obliquely extending setting surfaces 8.1, 8.2, 9.1, 9.2, which is also clear from the illustrations in FIGS. 5 and 6. The setting surfaces 8.1, 8.2, 9.1, 9.2 run at an angle to the plane of rotation of the manual control element 7, so that the rotary movement of the manual control element 7 can be converted into an axial movement via the inclined setting surfaces 8.1, 8.2, 9.1, 9.2. In this respect, the setting discs 8, 9 act together as a pair of lifting discs 12.

The setting surfaces 9.1, 9.2 of the setting disc 9, as well as the setting surfaces 8.1, 8.2 of the setting disc 8, each extend symmetrically around the valve axis A of the valve 1 over a circumferential angle α of slightly less than 180°. The setting surfaces 9.1, 9.2 of the setting disc 9, as well as the setting surfaces 8.1, 8.2 of the setting disc 8, are aligned parallel to each other and lie flat against each other. In the design example, the circumferential angle α is 160°, see also FIG. 6a) to c). This results in a uniform transmission of the actuating forces required to operate the push-push mechanism 4, which is less susceptible to wear. In the area between the setting surfaces 8.1, 8.2, 9.1, 9.2, stops 10, 11 are provided, which ensure that the manual control element 7 can only be turned back and forth between the stops 10, 11 over the maximum angle α. Over-rotation is prevented by the stops 10, 11.

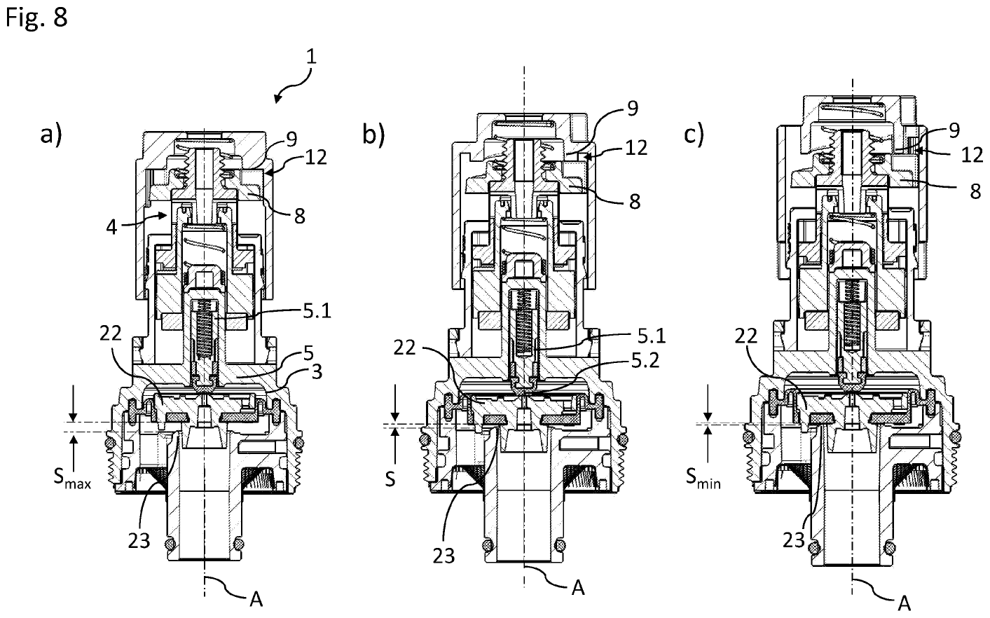

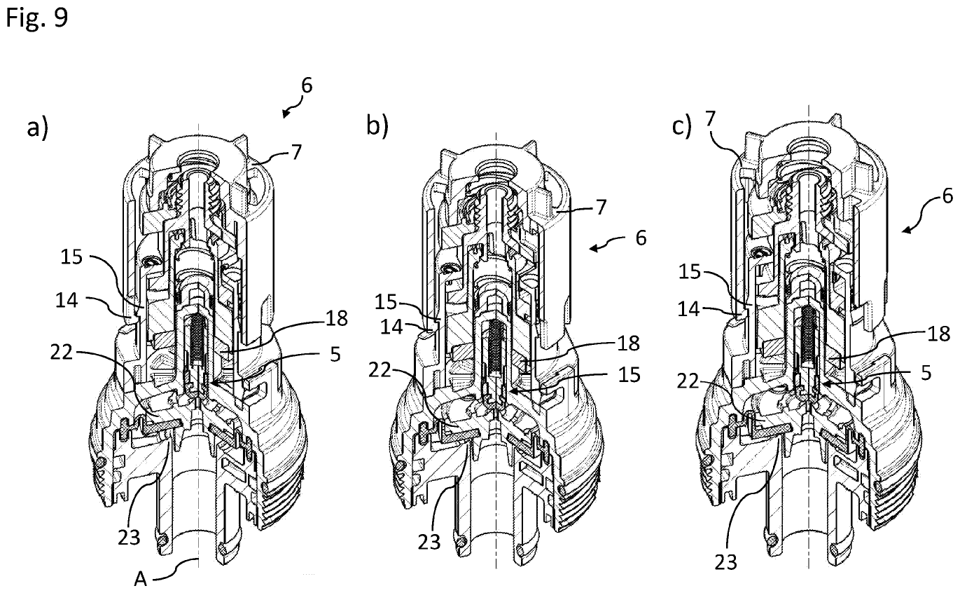

The setting surfaces 8.1, 8.2 of the setting disc 8 are designed to correspond to the setting surfaces 9.1, 9.2 of the setting disc 9, so that they lie flat against each other and together form a pair of setting or lifting discs 12, the function of which will be described in more detail below with reference to the illustrations in FIGS. 8 to 9.

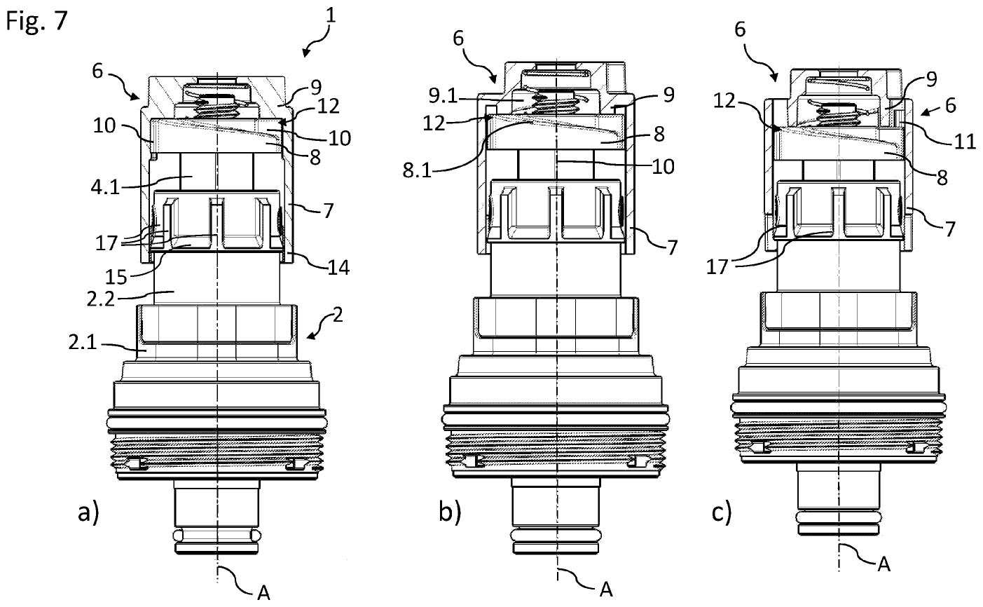

FIGS. 7 to 9 each show open positions of valve 1. The position labelled a) in FIGS. 7 to 9 corresponds to the maximum open position of valve 1, the position labelled b) corresponds to a medium open position and the position labelled c) corresponds to the minimum open position.

By manually applying an actuating pressure in the direction of the valve axis A of the valve 1, the manual control element 7 can be moved axially relative to the valve housing 2 of the valve 1. This movement is transferred to a pressure element 4.1 of the push-push mechanism 4 and used to switch valve 1 between the open position and the closed position of the main valve 3. During this movement, the latching elements 14 lift off the latching structure 15 in the direction of the push-push mechanism 4. After the push-push mechanism 4 has been operated, the operator removes his hand from the manual control element 7. The manual control element 7 is returned to its initial position.

The manual control element 7 can also be used to regulate the flow rate in the same way as a one-button operation. For this purpose, the manual control element 7 of the setting attachment 6 can be rotated around the valve axis A. When the manual control element 7 is rotated, the setting disc 9, which rotates together with the manual control element 7, rotates relative to the non-rotatable setting disc 8 arranged on the push-push mechanism 4. During the rotary movement, the cap 7 is axially secured against the latching structure 15 via the latching elements 14 and presses the pressure element 4.1 of the push-push mechanism 4 downwards due to the inclined angle of the setting surfaces 8.1, 8.2, 9.1, 9.2, as illustrated, for example, by comparison of the illustrations in FIGS. 7a) and 7b).

In the maximum open position according to the views labelled a), the setting surfaces 8.1, 8.2 of the setting disc 8 are in almost full contact with the setting surfaces 9.1, 9.2 of the setting disc 9 on the manual control side. The stops 10, 11 are also in contact with each other, so that a rotary movement of the manual control element 7 is only possible in one direction from the fully open position, as indicated by the directional arrow depicted in FIG. 7a).

To reduce the flow rate, the manual control element 7 can be moved from the maximum open position shown in FIG. 7a) to the intermediate position shown in FIG. 7b) by turning the manual control element 7 clockwise about the valve axis A. The angle of rotation for transferring the valve 1 from the position shown in FIG. 7a) to the intermediate position shown in FIG. 7b) is approximately 80° in the example embodiment.

By turning the manual control element 7, the setting disc 8, which forms a pair of lifting discs 12 together with the setting disc 9, is moved downwards in the axial direction and presses the pressure element 4.1 of the push-push mechanism downwards. The pilot control element 5.1 of the pilot valve 5, which serves as a hydraulic stop, also follows this pressure movement, which results in a smaller opening gap S between the closing element 22 and the valve seat 23 of the main valve 3 compared to the maximum opening gap Sₘₐₓ, see the illustrations in FIGS. 8a) and 8b).

In this position, only about half of the setting surfaces 8.1, 8.2 are in contact with the opposite setting surfaces 9.1, 9.2.

The minimum flow position shown in the figures labelled c) is achieved by turning the manual control element further, again by an angle of approximately 80°. In this position, the stops 10 of the setting disc 8 are in contact with the stops 11 of the manual control element 7. Further rotation in the closing direction is not possible. In this position, the gap between the valve seat 23 Sₘᵢₙ is minimal and the manual control element 7 can only be turned anti-clockwise in the opening direction from this position, as illustrated by the directional arrow shown in FIG. 7c).

The flow rate is regulated by adjusting the open position of the valve 1. To adjust the open position of the valve 1, the setting discs 8, 9, which are arranged to rotate against each other, can be rotated relative to each other using the manual control element 7. The setting discs 8, 9 are arranged outside the push-push mechanism 4. The setting discs 8, 9 act on the push-push mechanism 4 from the outside. By turning the setting discs 8, 9, the pressure element 4.1 of the push-push mechanism 4 is moved axially. The predetermined switching positions of the push-push mechanism 4, which are used to switch between the open and closed positions, remain unchanged.

When switching between the open and closed position by applying actuating pressure to the manual control element 7 in the direction of the valve axis A, the setting discs 8, 9 do not change their relative rotation to each other. Pressure on the manual control element 7 therefore switches between the closed position and the last open position set.

As the illustrations, in particular in FIGS. 7a) to 7c), show, both the rotary and axial movements of the manual control element 7 are guided by guide elements 17. The guide elements 17 are bars extending in the axial direction of the valve 1 and arranged on the outer circumference of the housing part 22 of the valve housing 2. The guide elements 17 are provided with slip-on bevels 17.1 to simplify the attachment of the manual control element 7.

The valve 1 described above is characterized by an easy handling and low wear. The push-push mechanism 4 can be actuated via the manual control element 7, i.e. the main valve 3 can be switched back and forth between its open and closed position, and the open position of the main valve 3 can also be continuously adjusted by rotating the manual control element 7 to regulate the flow rate. Due to the setting discs 8, 9 provided as setting elements, there is a favorable transmission of the adjusting forces and thus low wear.

### REFERENCE SIGNS

1 Valve
2 Valve housing
2.1 Housing part
2.2 Housing part
2.3 Connection point
2.4 Latching element
2.5 Latching element
3 Main valve
4 Push-push mechanism
4.1 Pressure element
4.2 Feed element
4.3 Sleeve
5 Pilot valve
5.1 Pilot control element
5.2 Sealing surface
6 Setting attachment
7 Manual control element
7.1 Casing
7.2 Base
7.3 Connection means
8 Setting element
8.1 Setting surface
8.2 Setting surface
8.3 Connection means
9 Setting element
9.1 Setting surface
9.2 Setting surface
10 Stop
11 Stop
12 Pair of lifting discs
13 Spring
14 Latching element
15 Latching structure
16 Tongue
17 Guide element
17.1 Slip-on bevel
18 Magnet
19 Base valve unit
20 Valve inlet
21 Valve outlet
22 Closing element
22.1 Control opening
23 Valve seat
24 Pressure chamber
A Valve axis
Sₘₐₓ Opening gap
S Opening gap
Sₘᵢₙ Opening gap
α Angle

What is claimed is:

1. A valve with a valve housing, a main valve and a pilot valve, which can be actuated via a push-push mechanism, for adjusting the main valve between an open and a closed position,
wherein the valve includes
two setting discs arranged to be rotatable relative to each other for setting the open position.

2. A valve according to claim 1, wherein the setting discs form a pair of lifting discs.

3. A valve according to claim 1, wherein the setting discs have inclined setting surfaces.

4. A valve according to claim 3, wherein the setting discs each have two setting surfaces.

5. A valve according to claim 4, wherein stops for limiting the rotary movement are arranged between the two respective setting surfaces.

6. A valve according to claim 1, wherein the setting discs are arranged on a setting attachment that is detachably mounted on at least one of the valve housing or the push-push mechanism, via which the open position can be set to regulate a flow rate.

7. A valve according to claim 6, wherein the push-push mechanism is operable via the setting attachment.

8. A valve according to claim 1, further including a manual control element, wherein the push-push mechanism is operable by pressing the manual control element and the open position can be set by rotating the manual control element.

9. A valve according to claim 1, wherein a setting disc is detachably connected to the push-push mechanism.

10. A valve according to claim 8, wherein a setting disc is arranged at the manual control element.

11. A valve according to claim 10, wherein the setting disc is connected to the manual control element in one piece.

12. A valve according to claim 8, wherein the manual control element is connected to the valve housing.

13. A valve according to claim 12, wherein the manual control element is connected to the valve housing in such a way that it can be moved axially in the direction of the push-push mechanism against the force of a tensioning spring and is rotatable relative to the valve housing.

14. A valve according to claim 10, wherein the manual operating element has latching elements which are latched to a latching structure arranged on the valve housing.

15. A valve according to claim 14, wherein the latching elements are formed on resilient tongues.

16. A valve according to claim 14, wherein the latching structure is designed in the form of a circumferential latching collar.
